(19) United States
(12) Patent Application Publication
(10) Pub. No.: US 2025/0103554 A1
(43) Pub. Date: Mar. 27, 2025

(54) SYSTEMS AND METHODS FOR AUTOMATED LOG FILE MANAGEMENT AND ENTERPRISE SECURITY

(71) Applicant: FoxIO, Inc., Austin, TX (US)

(72) Inventors: Thatcher Thornberry, Denver, CO (US); Bryce G. Blackwell, Dallas, TX (US); Joshua D. Alexander, Austin, TX (US)

(21) Appl. No.: 18/893,947

(22) Filed: Sep. 23, 2024

Related U.S. Application Data
(60) Provisional application No. 63/539,664, filed on Sep. 21, 2023.

(51) Int. Cl. G06F 16/16

(52) U.S. Cl. CPC G06F 16/16

(57) ABSTRACT

A method for automatically generating configurations for computing log file management includes the following steps. Log files are received from a log source. The log files are categorized into log file types. A determination is made as to whether a configuration is known or unknown for each log file type. If the configuration is known, then a merging strategy is applied to the log files having that configuration. If the configuration is unknown, then a new log file type configuration is created and stored. The log file types having the previously unknown configuration are then processed using the newly created configuration to reduce the data size.

### BACKGROUND OF THE DISCLOSURE

### Field of the Disclosure

The disclosure relates to systems and methods for automating log file management and other aspects of enterprise security.

### Description of the Related Art

Currently users and enterprises have to tailor a merging strategy for each unique log type/producer, define headers and fields within a log file manually before running a batching, filtering, or deduplication process. This process is known as defining the merge strategy. As an example—if a log file contained the fields—TIME, USER, ACTION, IP, SOURCE PORT—the user (e.g., an admin) would have to create a parser manually to set up the intake of the TIME column, the USER column, the ACTION column, the IP column, and the SOURCE PORT column. The process of defining each of these fields manually, for every different log source is cumbersome, makes the scalability of filtering and deduplication brittle, and leads to generally poor adoption of filtering and deduplication technologies. Essentially, the processor must have prior knowledge of the specific names of fields and knowledge of the data within those fields, and network/security analysts must tailor a merging strategy for each field and for each log type/producer. Thus, there is a need within the industry for systems and methods that are capable of automating log file intake, processing, and management.

### DETAILED DESCRIPTION OF THE INVENTION

Embodiments of systems and methods for creating merge strategies are disclosed herein. Merge strategies are defined as processes of defining an algorithm to handle the aggregation, summarization, and/or removal of log data. The logic of this algorithm is defined based on several things such as: the type of data to be merged, the utility of the data, the customer-specific use case for the data, etc. For example, if a piece of data is an IP address, depending on the application, it may be desirable to record all unique values, count all unique values, or even drop all of the values. Embodiments disclosed herein alleviate the burden of having to define these merge strategies manually while also offering an option for users to configure custom strategies if the automatically generated strategies not suitable.

Throughout this description, preferred embodiments and examples illustrated should be considered as exemplars, rather than as limitations on the present invention. As used herein, the term “invention,” “device,” “method,” “disclosure,” “present invention,” “present device,” “present method,” or “present disclosure” refers to any one of the embodiments of the invention described herein, and any equivalents. Furthermore, reference to various feature(s) of the “invention,” “device,” “method,” “disclosure,” “present invention,” “present device,” “present method,” or “present disclosure” throughout this document does not mean that all claimed embodiments or methods must include the referenced feature(s).

Relative terms such as “outer,” “above,” “lower,” “below,” “horizontal,” “vertical” and similar terms, may be used herein to describe a relationship of one feature to another. It is understood these terms are intended to encompass different orientations in addition to the orientation depicted in the figures.

Although the ordinal terms first, second, etc., may be used herein to describe various elements, components, or steps, these elements, components, or steps should not be limited by these terms. These terms are only used to distinguish one element, component, or step from another element, component, or step. Thus, a first element or component discussed below could be termed a second element or component without departing from the teachings of the present disclosure. As used herein, the term “and/or” includes all combinations of one or more of the associated list items.

The terminology used herein is for describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” “including,” “has,” “having,” and similar terms, when used herein, specify the presence of stated features, integers, steps, operations, elements, and/or components, but do not preclude the presence or addition of one or more other features, integers, steps, operations, elements, components, and/or groups thereof.

In one exemplary embodiment, using an open source library, a named entity recognition (NER) model was trained on labeled log data. The model can automatically detect the data type of a log source field.

A “top-level configuration” which maps data labels to a merging strategy was defined. For example, the data label “ip address” maps to a unique merging strategy, which records all unique values. Thus, when data comes in, after identifying the data type, a merging strategy is automatically assigned. Giving users the ability to modify the “top-level configuration” provides flexibility such that the process can be tailored to specific organizational requirements.

Additionally, a “bottom-level configuration” is created to define the merging strategy for a specific log type. For example, if a log has the fields TIME, USER, ACTION, based on the unique order and names of the fields, a merging strategy can be created that is specific to this log using the “top-level configuration.” When the log is received, the NER model runs to determine the data within it. For the field TIME, it is determined to be of data type “timestamp.” Using the “top-level configuration”, the merging strategy of this data type is determined to be “range” (which records the minimum and maximum values). Using this information, a “bottom-level configuration” is created which maps each field name to a merging strategy (TIME>range). This provides two benefits. First, when a log of this type is received, it can be determined that a “bottom-level configuration” has already been generated. If it has, then the process of rerunning the NER model can be avoided. Second, giving users the ability to modify the “bottom-level configuration” allows the process to be customized according to particular use case requirements. As an example, for most timestamp data, a particular user may want to record a range of values. However, for a specific log producer, that user may require that every piece of timestamp data be preserved.

Running this NER process may drastically reduce the time to implement filtering and deduplication technologies, which in turn may dramatically improve the processing time and security offered through SIEMs.

The following is an exemplary process according to an embodiment of the disclosure:
Step 1—Intake of log files from log source;
Step 2—NER processes sample data in log files and creates automated merge strategy;
Step 3—Deduplication of log files using the merge strategy defined in step 2;
Step 1—Processor receives log data;
Step 2—Generation of a unique identifier (hash) which stores the order and values of the field headers;
Step 3—Check if a “bottom-level configuration” has been created for this specific log type;
Step 3.1—If a “bottom-level configuration” has not been created, pass a sample of the data to our NER model, else proceed to 4;
Step 3.2—NER model labels each data point as a certain data type;
Step 3.3—A voting mechanism determines the data type for each field;
Step 3.4—The “top-level configuration” maps each field header to a merging strategy (based on the data type);
Step 3.5—Save the “bottom-level configuration” using the unique identifier for further use; and
Step 4—The “bottom-level configuration” merges data based on the merging strategy defined for each field.
   It is understood that more or fewer steps are possible.

In another embodiment of the present disclosure, a process is used to automate log normalization in log management and enterprise security environments. This process enables efficient and scalable processing of logs. The process may eliminate the need for SIEMs to be bogged down with many named fields for the same data.

An embodiment of the named entity recognition algorithm (NER) automatically detects the field type of a log source by comparing sample data in the field and the header of the field to a sufficiently large dataset of previously identified field types.

Using an open source library, an additional NER model was trained on labeled log data. With this, the model can automatically detect the ideal header title for any given field using a combination of the original header title and the data it holds.

Running this NER process may drastically improve the ability to combine log source data into a single field name, which in turn may improve the processing time and security offered through SIEMs.

An exemplary embodiment of such a process is described below:
Step 1—Intake of log files from log source;
Step 2—NER processes sample data in log files and creates automated merge strategy;
Step 3—“like data” is combined into the same named field—providing Log Normalization;
Step 1—Log data is received by a processor;
Step 2—Generate a unique identifier (hash) which stores the order and values of the field headers;
Step 3—Check if a “bottom-level configuration” has been created for this specific log type;
Step 3.1—If a “bottom-level configuration” has not been created, pass a sample of the data to the NER model, else proceed to 4;
Step 3.2—The NER model labels each data point as a certain data type;
Step 3.3—A voting mechanism determines the data type for each field;
Step 3.3.1—A separate NER model analyzes the value of the header name and the determined data type—this model will determine the normalized header name;
Step 3.4—The “top-level configuration” maps each field header to a merging strategy (based on the data type);
Step 3.5—The “bottom-level configuration” is saved using the unique identifier for further use; and
Step 4—The “bottom-level configuration” merges data based on the merging strategy defined for each field.
   It is understood that more or fewer steps may be used in the process.

The various exemplary inventive embodiments described herein are intended to be merely illustrative of the principles underlying the inventive concept. It is therefore contemplated that various modifications of the disclosed embodiments will without departing from the inventive spirit and scope be apparent to persons of ordinary skill in the art. They are not intended to limit the various exemplary inventive embodiments to any precise form described. Other variations and inventive embodiments are possible in light of the above teachings, and it is not intended that the inventive scope be limited by this specification, but rather by the claims following herein.

Although the present invention has been described in detail with reference to certain preferred configurations thereof, other versions are possible. Embodiments of the present invention can comprise any combination of compatible features shown in the various figures, and these embodiments should not be limited to those expressly illustrated and discussed. Therefore, the spirit and scope of the invention should not be limited to the versions described above. Moreover, it is contemplated that combinations of features, elements, and steps from the appended claims may be combined with one another as if the claims had been written in multiple dependent form and depended from all prior claims. Combination of the various devices, components, and steps described above and in the appended claims are within the scope of this disclosure. The foregoing is intended to cover all modifications and alternative constructions falling within the spirit and scope of the invention.

We claim:

1. A method for automatically generating configurations for computing log file management, comprising:
receiving log files from a log source, each of said log files comprising a plurality of log file fields;
categorizing each log file into one of a plurality log file types by analyzing said log file fields and data contained in each of said log files;
determining if a configuration is known for each log file type;
if a particular configuration is known, then:
extracting a merging strategy from each known configuration for a given log file; and
applying said merging strategy to each of said log files having one of said known configurations to reduce data size of said log files;
if a particular configuration is unknown, then:
passing a sample of said log files having an unknown configuration to a named entity recognition (NER) model;
using said NER model, determining a semantic type of each log file field for each of said sampled log files;
assigning a merging strategy to each log file field of said sampled log files to create a new log file type configuration;
saving each of said new log file type configurations;
extracting a merging strategy from each of said new log file type configurations; and
applying said merging strategy to each of said log files of one of said new log type file configurations to reduce data size of said log files.
